(19) United States
(12) Patent Application Publication
(10) Pub. No.: US 2014/0094950 A1
(43) Pub. Date: Apr. 3, 2014

(54) METHOD FOR THE PRODUCTION OF AN ABRADABLE SPRAY COATING

(71) Applicant: MTU Aero Engines AG, Munich (DE)

(72) Inventors: Andreas Jakimov, Muenchen (DE); Manuel Hertter, Muenchen (DE); Andreas Kaehny, Muenchen (DE)

(73) Assignee: MTU Aero Engines AG, Munich (DE)

(21) Appl. No.: 14/097,127

(22) Filed: Dec. 4, 2013

Related U.S. Application Data
(63) Continuation-in-part of application No. 12/529,335, filed on Aug. 31, 2009, now abandoned.

(30) Foreign Application Priority Data
Mar. 1, 2007 (DE) 10 2007 010 049.5

(51) Int. Cl. F01D 5/28; G05B 15/02

(52) U.S. Cl. CPC F01D 5/28; G05B 15/02
USPC 700/117

(57) ABSTRACT

A method for producing an abradable spray coating for a component of a turbine engine by a thermal spraying process is disclosed. A process parameter p_{B1} is calculated according to the formula p_{B1}=p_{B2}+H_{B1}−H_{B2}−(Δx·y)/z+n where p_{B1} is a process parameter of a spraying process that is to be conducted, p_{B2} is a corresponding process parameter of a previous spraying process, H_{B1} is a hardness of a coating that is to be applied by the spraying process to be conducted, H_{B2} is a hardness of a coating that was applied by the previous spraying process, Δx is a process variable related to the thermal spraying process and the previous spraying process and y, z and n are constant parameters.

This application is a continuation-in-part of prior application Ser. No. 12/529,335, filed Aug. 31, 2009, which claims the benefit of International Application No. PCT/DE2008/000333, filed Feb. 25, 2008, and German Patent Document No. 10 2007 010 049.5, filed Mar. 1, 2007, the disclosures of which are expressly incorporated by reference herein.

### BACKGROUND AND SUMMARY OF THE INVENTION

The invention relates to a method for producing a spray coating, in particular an abradable spray coating for components of a turbine engine. Furthermore, the invention relates to a device for carrying out this method.

In order to increase the degree of efficiency of turbine engines, in particular for aviation, current compressor development is aimed at increasing pressure ratios. Furthermore, the requirement for a lighter structure, which is possible, for example, by reducing the number of stages, produces an increase in the pressure ratio between the compressor stages. A side effect of this development is an increase in the backflow from the pressure side to the suction side of the compressor blades.

As a result, the significance of the sealing system, which prevents the backflow described above between the rotating compressor blades and the compressor housing, has become ever more important. This sealing system is an important element of the degree of efficiency and has a substantial impact on the so-called pump line and therefore on the stable operation of the engine.

In order to prevent a high backflow rate, it is necessary to reduce the gap between the rotating compressor blades and the compressor housing as much as possible. Because of the different operating states during operation of an engine such as, for example, acceleration, idling, stationary operation, etc., the tips of the rotating rotor blades can touch the inside wall of the compressor housing or even experience running-in. Furthermore, running-in may also occur due to an eccentricity of the rotor or housing, which can be caused by flight maneuvers, for example.

In order to prevent greater damage in the case of a running-in of the rotating rotor blades in the compressor housing, potential contact surfaces of the housing are provided abradable coatings, so-called running-in coatings.

So that the blades can work into the corresponding locations on the compressor housing, it must be relatively easy to abrade the coating material without damaging the tips of the blades. Moreover, the coating must also possess good resistance to particle erosion and other degradation at elevated temperatures.

For this type of coating, U.S. Pat. No. 5,434,210 discloses a thermal spray powder and a composite coating made of this powder, which has a matrix component, a dry lubricant component and a synthetic component. A corresponding powder for thermal spraying can be procured from Sulzer Metco Co. under the designation SM2042.

Thermal spraying designates a method for producing a spray coating on a surface of a substrate, wherein filler materials are directed onto the to-be-coated surface of a substrate with the use of a gas. German Patent Document No. DE 102004041671 A1 describes this type of method and a monitoring system for quality assurance of the sprayed layers. It is a so-called PFI (particle flux imaging) method in this case.

In the case of the PFI system described in DE 102004041671 A1, a cluster of the particles that influence the quality of the spray layer is recorded with a digital camera. This image is then depicted or further processed by arithmetic analysis.

This makes diagnostics of a thermal spraying process possible.

Furthermore, European Patent Document No. EP 1 332 799 A1 describes a device and a method for thermal spraying, in which a partly fused or molten filler material is directed onto the to-be-coated surface of a substrate with the use of a gas or gas mixture. In doing so, at least one characteristic of the thermal spraying process that influences the quality of the spray layer, which is responsible for the development of the layer and its properties, is recorded, analyzed and regulated by means of an optical spectroscopy arrangement. As a result, a possibility for the online regulation and optimization of one or more parameters that are responsible for the development of the spray coating is provided.

Despite the method for the quality assurance of thermal spraying processes described above, it has not been possible up to now to reproducibly produce an abradable spray coating having a low hardness, in particular from the SM2042 powder, but also from other materials for components. This is due above all to the very unstable spraying process. In particular, it is currently not possible to produce a coating to specifications when there are process deviations. Currently, the hardness of the coating can only be measured in a burned-off state, whereby approximately one day is lost before the spraying process can be continued. In the process, the spraying conditions may change during the waiting period. However, if this procedure is omitted, it results in very high rates of post-processing of the coated components.

The objective of the invention is therefore to avoid the technical problems of the prior art described in the foregoing and to provide an improved method for producing an abradable spray coating, which makes it possible to monitor the spraying process using defined parameters. Furthermore, a device for carrying out the method is made available.

### DETAILED DESCRIPTION OF INVENTION

The invention avoids the technical problems of the prior art and provides an improved method and an improved device for producing an abradable spray coating in a reliable process.

The inventive method for producing a spray coating, in particular an abradable spray coating for components of a turbine engine by means of a thermal spraying process, wherein an online process monitoring system, especially a PFI unit and/or a spectrometer unit, is provided for monitoring and regulating the thermal spraying process, is characterized in that at least one process parameter of the spraying process is calculated according to the formula:

p_{B1}=p_{B2}+H_{B1}−H_{B2}−(Δx·y)/z+n.

p_{B1} is a process parameter for the spraying process of the coating that is to be applied and p_{B2} is the same process parameter for a previous spraying process that applied a previous coating. For example, pm is the distance in mm of the burner used in the new spraying process from the component that is to receive the new coating and p_{B2} is the distance in mm of the burner used in the previous spraying process from the component that received the previous coating. Thus, parameter p_{B1} is a corresponding parameter to p_{B2}; they are parameters for the same feature of different spraying processes.

Whereas distance of the burner is discussed above as the corresponding process parameters of the two spraying processes, the present invention is not limited to this process parameter and any of a variety of process parameters of the spraying processes can be the subject of the present invention, e.g., gas flow rate (1/min), voltage (V), amperage (A), etc. In particular, the primary gas rate and the secondary gas rate are possible spraying process parameters. The relation between primary and secondary gas rate controls the gas temperature and gas velocity, which takes effect on the particle temperature and velocity. The coating properties such as porosity or hardness are highly influenced by these parameters. In addition, other spraying process parameters not cited here may be regulated by the inventive method and namely in such a way that a reproducible result of the spray layer applied is yielded.

H_{B1} is the hardness of the spray coating that is to be applied by the spraying process that is to be conducted. H_{B2} is the hardness of the spray coating applied by the previous spraying process.

Δx is a process variable related to the current spraying process and the previous spraying process. The variable Δx is determined from a relation of a process variable of the previous spraying process and a corresponding process variable of the current spraying process. It can be determined from the respective luminance distributions of the plasma and/or particle beam of the current spraying process and of the previous spraying process, which are recorded by the PFI unit or the spectrometer unit.

The difference of the semiaxes of the ellipses from the respective luminance distributions from the measurement of the PFI unit can be used to determine the variable Δx. The semiaxes are results given by the PFI unit in a percentage (%). Thus, Δx=the difference in the semiaxes; the x value (horizontal half axis from the ellipse described by equal particle intensity) of the part being coated−the x value (horizontal half axis from the ellipse described by equal particle intensity) of the part previously coated. As an example, Δx=50% (part being coated)−40% (part previously coated)=10%. The input in the equation would be the value 10. However, the present invention is not limited to any particular value for Ax or to any particular method for determining Δx. All that is required is that a variable be determined that relates the current spraying process and the previous spraying process.

The constant factors y and z are determined by experimental trials to adjust the correlation between the Δx variable of the PFI online process monitoring system and the respective process parameter. For abradable coatings the values for y and z lie advantageously between 0 and 15, wherein the interval limits are included. Depending on the coating properties y is preferably between 2 and 5, in particular preferably 3, while z is preferably between 8 and 12 and in particular preferably 10. The y and z parameters are unitless parameters, thus, they have no units in the equation. Only their values are utilized in the equation. The present invention is not limited to any particular values for y and z or to any particular method for determining y and z. All that is required is that parameters that are based on a correlation between a process variable of the online process monitoring system and the respective process parameter to be calculated are taken into consideration in the equation.

The constant parameter n takes a change in the type of component coated in the two spraying processes into consideration, e.g., one part was coated in the previous spraying process and a different geometry of the part to be coated in the spraying process to be conducted. n lies for abradable coatings in particular between −10 and +10, in particular between −5 and +5, wherein the interval limits are included in each case. This value has to be determined by experimental correlation research for each part geometry. Similar to the y and z parameters, n is also a unitless parameter, thus, it has no units in the equation. Only its value is utilized in the equation. The present invention is also not limited to any particular values for n or to any particular method for determining n. All that is required is that a change in the types of components coated in the two spraying processes be taken into consideration in the equation.

Thus, with the present invention, it is hereby possible, based on previous spraying processes and the properties of the coating of these previous spraying processes, for abradable spray coatings to be produced in a reliable spraying process to be conducted, without great delay and the associated changes to basic conditions.

An advantageous further development of the method provides for the coating to be carried out with SM2042 powder. This powder is especially suited for applications with axial turbo-machines.

Another advantageous further development of the method provides for the calculation of the process parameter of the spraying process to be carried out after adjusting the desired process parameter online or as an alternative to this before or after each coating. Implemented in a closed loop process control, the process parameter(s) can then be adjusted automatically, e.g., using actuators, or manually under constant monitoring.

Another advantageous further development of the method provides for the spray coating to be applied to a compressor housing. Because of the method, a running-in coating can now be reproducibly produced with a low hardness.

An inventive device for carrying out the inventive method features for online process monitoring, on the one hand, a PFI monitoring system and/or an optical emission spectroscopy unit, whose process monitoring characteristics are correlated in an arithmetic unit, whereby a reproducible spray coating can be produced in the case of process of deviations. Furthermore, actuators can be provided here to automatically adjust the process parameters.

Additional measures improving the invention are presented in greater detail in the following along with the description of a preferred exemplary embodiment of the invention.

The use of process monitoring serves to avoid post-processing as well as quality monitoring and documentation of the spraying process. With this method, the properties of the plasma and the particles in the plasma beam are recorded and correlated with the layer properties. If the measured properties deviate from a reference standard defined in advance, corrective action must be taken to prevent post-processing.

To this end, the multifunction process monitoring system is equipped with an Online Particle Flux Imaging (PFI) System, an optical spectrometer and a radiation pyrometer. The PFI system is used to check the plasma beam before and after coating the component. The spectrometer also makes quality monitoring possible during the spraying process.

The hardness of the layer to be applied (H_{B1}; measured in HR15Y) can now be regulated or monitored by use of a process parameter (pm; p_{B2}) and a process variable (Δx). To this end, the hardness of the previously produced layer (H_{B2}), the process parameter (p_{B1}; p_{B2}), and the process variable (Δx), as well as the constant parameters (y, z, and n) are incorporated into the regulation or calculation.

In selecting the distance between the component and burner (pm), good results have been obtained for y=3 and z=10 as constant parameters, in particular when information from the values measured using the PFI unit, particularly the luminance distribution of the plasma and/or particle beam from the current spraying process and a previous spraying process, is used as the process variable Δx. As discussed above, the change in the semiaxes of the measured ellipses from the current spraying process and a previous spraying process are used in particular in this case. However, it is also possible to use the center of gravity of the ellipses or the angle of the semiaxes in determining Δx.

The optical spectrometer uses a measuring head to record the light emitted when spraying plasma and the particles, and conveys it via a fiber-optic cable to a highly sensitive spectrograph. Chronological tracking of the entire spectral emission as well as several characteristic measuring lines of the overall spectrum make it possible to detect and save changes in intensity.

Moreover, the radiation pyrometer is used for contactless temperature measurement during the coating process. It guarantees the recording and graphic output of the measuring data from the entire coating process.

The measuring structure and the adjustment of the PFI and the optical spectrometer are not meant to be addressed in detail here.

In terms of its design, the present invention is not restricted to the preferred exemplary embodiment disclosed in the foregoing. In fact, a number of variations are conceivable, which make use of the described solution even in the case of fundamentally different designs.

The below further explanation provides an example of the use of the present invention with respect to the EJ200 turbofan engine.

When coating the same type of part in any stage of the engine in the two spraying processes, e.g., a blade, or when coating a different type of part in the two spraying processes, e.g., a blade for the current spraying process and a rotor in the previous spraying process, but where these different types of parts are used in either of stages 2, 3 and 4 of the engine, these same types of parts and different types of parts are both defined as having no change in the type of component coated in the two spraying processes. Therefore, in the equation for determining the distance (D) of the burner from the component to be coated, below, the n value is 0. Further exemplary values for the parameters of the equation are also given below for the equation:

D (spraying process that is to be conducted)=D (previous spraying process)+H (part being coated)−H (part coated in previous spraying process)−(Δx·y)/z+n;

where:

D is the distance in mm;

H is the hardness in HR15Y;

Δx=10

y=3

z=10

n=0

Thus, D (spraying process that is to be conducted)=15 mm+30−20 −(10·3)/10+0 such that D (spraying process that is to be conducted)=15 mm+10−3=22 mm.

Therefore, as can be understood from the above equation, D (spraying process that is to be conducted) is determined based on a previous spraying process.

Of course, different values for the parameters can be used. Further, as can be also be understood, if D (spraying process that is to be conducted) is known and inserted into the equation, then the only unknown is H (part being coated) and this parameter can then be determined/monitored/regulated in the current spraying process.

As an additional example, when currently coating a part from stage 1 of the engine when previously a part from stage 2, 3 or 4 was coated, the equation above can remain the same except for the parameter n. Now, since there is a change in the type of component coated in the two spraying processes, n, which takes this change in the type of component coated in the two spraying processes into consideration, now has a value of −5. Of course, the other parameters can change as well based on the particulars of the two spraying processes.

Thus, D (spraying process that is to be conducted)=15 mm+30−20−(10·3)/10−5 such that D (spraying process that is to be conducted)=17 mm.

As a further example, when currently coating a part from stage 2, 3, or 4 of the engine when previously a part from stage 1 was coated, the equation above can also remain the same except for a further change in the parameter n to account for this change in the type of component coated in the two spraying processes. Now, for this change in the type of component, n has a value of +5. Of course, again, the other parameters can change as well based on the particulars of the two spraying processes.

Thus, D (spraying process that is to be conducted)=15 mm+30−20−(10·3)/10+5 such that D (spraying process that is to be conducted)=27 mm.

As such, the equation of the present invention is directed to determining a process parameter for a thermal spraying process to be conducted based on a corresponding process parameter for a previous spraying process, a hardness of a spray coating to be applied, a hardness of a spray coating previously applied, and using parameters to define deviations in the spraying processes, e.g., Δx, y, z, and n.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing an abradable spray coating for a component of a turbine engine by a thermal spraying process, comprising the steps of:
monitoring and regulating the thermal spraying process by an online process monitoring system, wherein a process parameter pm is determined for the thermal spraying process according to the formula:
p_{B1}=p_{B2}+H_{B1}−H_{B2}−(Δx·y)/z+n;
wherein p_{B1} is a process parameter of the thermal spraying process that is to be conducted, p_{B2} is a corresponding process parameter to p_{B1} of a previous spraying process, H_{B1} is a hardness of a coating that is to be applied by the thermal spraying process to be conducted in HR15Y, H_{B2} is a hardness of a coating that was applied by the previous spraying process in HR15Y, Δx is a process variable related to the thermal spraying process and the previous spraying process, and y, z and n are constant parameters.

2. The method according to claim 1, wherein the online process monitoring system is a particle flux imaging (PFI) unit and/or a spectrometer unit.

3. The method according to claim 1, wherein the process parameter p_{B1} is calculated online.

4. The method according to claim 1, wherein the spray coating is applied to a compressor housing.

5. The method according to claim 1, wherein the parameters y and z lie between 0 and 15.

6. The method according to claim 1, wherein the parameter n lies between −10 and +10.

7. The method according to claim 1, wherein the process parameter of the thermal spraying process that is to be conducted and the corresponding process parameter of the previous spraying process is a primary gas rate, a secondary gas rate, or a distance between a component to be coated and a burner used in the thermal spraying process.

8. The method according to claim 1, wherein the process variable Ax is determined from a relation of a process variable of the previous spraying process and a corresponding process variable of the thermal spraying process.

9. The method according to claim 1, wherein the process variable Δx is determined from a luminance distribution of a plasma and/or a particle beam of the thermal spraying process and of the previous spraying process.

10. The method according to claim 9, wherein the luminance distribution is established by determining semiaxes of an ellipse for the plasma and/or the particle beam.

11. A device for carrying out the method according to claim 1, wherein the monitoring is performed by a particle flux imaging (PFI) monitoring system and/or an optical emission spectroscopy unit, whose process monitoring characteristics are correlated in an arithmetic unit, whereby a reproducible spray coating is producible in process with process deviations.
